(19) United States
(12) Patent Application Publication
(10) Pub. No.: US 2025/0194799 A1
(43) Pub. Date: Jun. 19, 2025

(54) SHELF BRACKET, HOOK AND BUCKET HOLDER

(71) Applicant: Edwin Howard Ferree, JR., Candler, NC (US)

(72) Inventor: Edwin Howard Ferree, JR., Candler, NC (US)

(21) Appl. No.: 19/072,672

(22) Filed: Mar. 6, 2025

Related U.S. Application Data
(63) Continuation-in-part of application No. 18/769,030, filed on Jul. 10, 2024.
(60) Provisional application No. 63/628,296, filed on Jul. 10, 2023.

(51) Int. Cl. A47B 96/06; F16M 13/02

(52) U.S. Cl. CPC A47B 96/06; F16M 13/02

(57) ABSTRACT

A shelf bracket not only supports a standard shelf, but has additional support members underneath to support a five-gallon bucket, for example, so that the bucket could be used as a storage bin that can easily be removed with the contents still inside. Having the end of the bucket open and exposed like a bin allows for better visibility and access to its contents. The bucket is supported at an angle, sloping towards the bottom or closed end of the bucket to prevent the contents from inadvertently falling out. Removing the bucket from the rack requires raising the front or open end of the bucket to a steeper angle therefore preventing any of the contents from falling out in the process. The bucket can be used as a bin that can be removed and moved to a vehicle for transport without removing any of the stored material.

### CROSS-REFERENCE TO RELATED APPLICATIONS

This application is a continuation-in-part of U.S. patent application Ser. No. 18/769,030, filed Jul. 10, 2024, the contents of which are herein incorporated by reference.

### BACKGROUND OF THE INVENTION

### 1. Field of the Invention

Embodiments of the invention relate generally to storage solutions. More particularly, embodiments of the invention relate to a shelf bracket, hook and bucket holder for holding buckets, such as five-gallon buckets.

### 2. Description of Prior Art and Related Information

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Many homeowners and professional workers use inexpensive and easily accessible four and five gallon buckets for storage. Sometimes referred to as “spackle buckets”, they are very durable and extremely useful for storing and transporting a huge variety of items. Although there is an increasing need for storage in homes and businesses, commercially available shelf brackets, hooks, and bins do not adequately accommodate the increasing use of the five-gallon bucket. Stacking buckets on top of each other hinders visibility of the contents and hampers easy access. If the buckets are turned on the side and placed on a shelf like a bin, the items in the bucket tend to slide out. Also when laid on the side, the buckets take up a lot of shelf space and storing items on top of buckets would be problematic.

In view of the foregoing, there is a need for a unique shelf, hook and bin bracket system for supporting buckets, such as five-gallon buckets.

### SUMMARY OF THE INVENTION

Embodiments of the present invention provide a shelf bracket and bucket rack comprising a base member having a back surface operable for attachment to a surface; an upper arm extending from a top of the back surface, the upper arm extending generally perpendicularly from the base member, the upper arm having an upper surface configured to retain a shelf thereupon; a bent member formed at a distal end, relative to the base member, of the upper arm, the bend extending the upper arm back toward the base member; and first and second bucket support arms connected to a lower end of the base member, the first and second bucket support arms extending away from the base member, the first and second bucket support arms spaced apart from each other and configured to support a side of a bucket positioned thereupon.

Embodiments of the present invention further provide a shelf bracket storage apparatus comprising a bucket and a shelf bracket and bucket rack comprising a base member having a back surface operable for attachment to a surface; an upper arm extending from a top of the back surface, the upper arm extending generally perpendicularly from the base member, the upper arm having an upper surface configured to retain a shelf thereupon; a bent member formed at a distal end, relative to the base member, of the upper arm, the bend extending the upper arm back toward the base member; and first and second bucket support arms connected to a lower end of the base member, the first and second bucket support arms extending away from the base member, the first and second bucket support arms spaced apart from each other and configured to support a side of the bucket positioned thereupon, wherein the bucket is removable from the shelf bracket and bucket rack; and the bucket is configured to rest the bent member inserted into an open end of the bucket, a bottom side of the bucket supported by the first and second bucket support arms, and a closed end of the bucket positioned against the base member.

These and other features, aspects and advantages of the present invention will become better understood with reference to the following drawings, description and claims.

### BRIEF DESCRIPTION OF THE DRAWINGS

Some embodiments of the present invention are illustrated as an example and are not limited by the figures of the accompanying drawings, in which like references may indicate similar elements.

FIG. 1 illustrates a perspective view of a shelf bracket and bucket rack, having a bucket disposed thereupon, according to an exemplary embodiment of the present invention;

FIG. 2 illustrates a perspective view of the shelf bracket and bucket rack of FIG. 1;

FIG. 3 illustrates a perspective view of a shelf bracket and bucket rack, configured in a tubing design, according to an exemplary embodiment of the present invention;

FIG. 4 illustrates a perspective view of a shelf bracket and bucket rack, configured as a tubing design, according to an exemplary embodiment of the present invention;

FIG. 5 illustrates a perspective view of the shelf bracket and bucket rack of FIG. 3, with a bucket held therein;

FIG. 6 illustrates a perspective view of a shelf bracket and bucket rack, having a bucket disposed thereupon, according to an exemplary embodiment of the present invention;

FIG. 7A illustrates a first component of a shelf bracket and bucket rack, according to an exemplary embodiment of the present invention;

FIG. 7B illustrates a second component of the shelf bracket and bucket rack of FIG. 7A;

FIG. 7C illustrates a cross sectional view taken along line A of FIG. 7A;

FIG. 7D illustrates a cross sectional view taken along line B of FIG. 7A;

FIG. 7E illustrates a cross sectional view taken along line C of FIG. 7B; and

FIG. 8 illustrates a side view of FIGS. 7A through 7E, with additional features of a closet rod holder and a utility hook, according to an exemplary embodiment of the present invention.

Unless otherwise indicated illustrations in the figures are not necessarily drawn to scale.

The invention and its various embodiments can now be better understood by turning to the following detailed description wherein illustrated embodiments are described. It is to be expressly understood that the illustrated embodiments are set forth as examples and not by way of limitations on the invention as ultimately defined in the claims.

### DETAILED DESCRIPTION OF THE PREFERRED EMBODIMENTS AND BEST MODE OF INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention, and is not intended to limit the invention to the specific embodiments illustrated by the figures or description below.

As is well known to those skilled in the art, many careful considerations and compromises typically must be made when designing for the optimal configuration of a commercial implementation of any system, and in particular, the embodiments of the present invention. A commercial implementation in accordance with the spirit and teachings of the present invention may be configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

Broadly, embodiments of the present invention provide a shelf bracket that not only supports a standard shelf on a top side thereof, but has additional support members underneath configured in such a way as to support additional items including, but not limited to, a five-gallon bucket so that the bucket could be used as a storage bin that can easily be removed with the contents still inside. Having the end of the bucket open and exposed like a bin allows for better visibility and access to its contents. Typically, the bucket is supported at an angle, sloping towards the bottom or closed end of the bucket. By storing the bucket on an angle and being sloped towards the bottom or closed end of the bucket, the configuration can prevent the contents from falling out. Removing the bucket from the rack requires raising the front or open end of the bucket to a steeper angle therefore preventing any of the contents from falling out in the process. The bucket can be used as a bin that can be removed and moved to a vehicle for transport without removing any of the stored material.

A wide variety of items and materials can be placed in the bucket bin such as, but not limited to, power tools, hand tools, caulking tubes, paint brushes, bolts, screws, nails, sports helmets, shoes, boots, bird seed, pet food or anything else that will fit in a bucket.

Each bracket could be individually attached to any vertical surface such as a wall framing member, a free standing post, a drywall covered wall, or a masonry wall. As an alternative attachment method, a horizontal track could be secured to a vertical surface and multiple brackets could be hung from the track. The brackets or track would be attached with screws, nails, hollow wall fasteners, masonry fasteners, steel fasteners or the like.

The system could be used by homeowners and hobbyists, including but not limited to, in garages, sheds, basements and workshops. Another use could be professional construction workers such as carpenters, plumbers, electricians and other trades. Some other uses would be for construction trailers, warehouses and vendors of various materials and supplies.

While two configurations with five different material types are described here and illustrated in the Figures, it should be understood that various configurations may be contemplated within the scope of the present invention. One configuration of the design would be that the bucket is partially supported at the bottom while the top of the bucket is supported by a hook with stepped cleat-like catches to prevent the different size buckets from sliding forward and falling while its contents are being accessed. Another configuration of the design would be that the bottom hooks support 100% of the weight and has a second turned-up hook at the end to prevent the bucket from sliding out while accessing its contents. These configurations as well as other aspects of the present invention are described in greater detail below, referencing the appropriate figures.

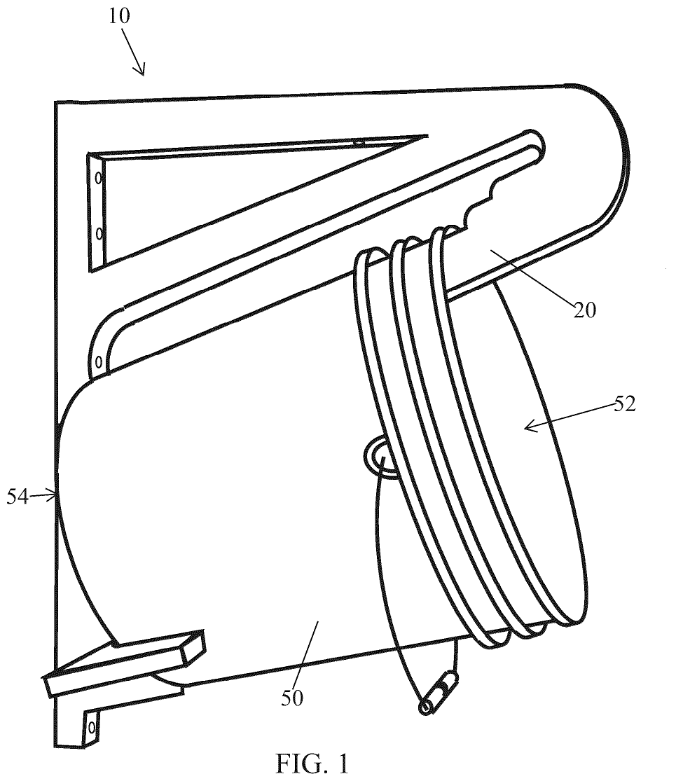

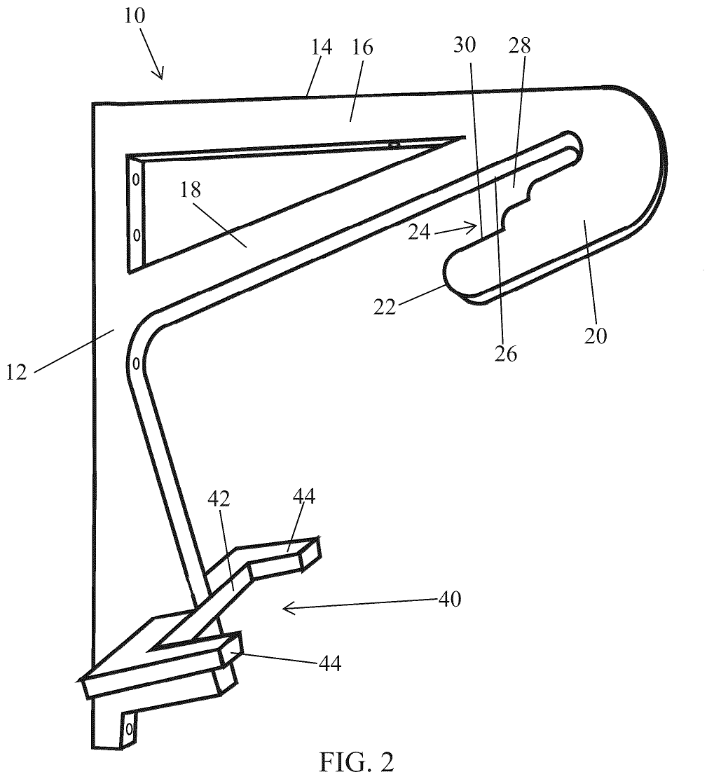

Referring to FIGS. 1 and 2, a shelf bracket and bucket rack 10 (also referred to as shelf bracket 10 or bucket rack 10) can include a base member 12 for attachment to a wall (not shown) or other surface. A top surface 14 of the shelf bracket 10 can be flat and be configured for placement of a shelf member (not shown) thereupon. An upper arm 16, that extends from the base member 12, can form the top surface 14. A diagonal support arm 18 can extend diagonally from the base member 12 (below the upper arm 16) to connect to a distal end of the upper arm 16 (distal relative to the base member 12). A distal end of the upper arm 16 may form a bent member 20 so that the distal end 22 of the bent member 20 extends back to point toward the base member 12. A plurality of steps 24 may be formed in an interior surface of the bent member 20, where the steps 24 face a bottom portion 26 of the diagonal support arm 18. A space 28 can be formed between an upper surface 30 of the bent member 20 and the bottom portion 26 of the diagonal support arm 18. Typically, the base member 12, the upper arm 16 and the diagonal support arm 18 may be integrally formed, as best illustrated in FIG. 2.

A support hook 40 can be disposed at a lower end of the base member 18. The support hook may be formed in a generally C-shape, typically a squared C-shape as shown in FIG. 2. The support hook 40 can include a base 42 that is attached to of formed integrally with the base member 12. Support hook arms 44 can extend from opposite ends of the base 42, extending away from the base member 12.

A bucket 50, having an open end 52 and a closed end 54, can be placed on the bucket rack 10 by inserting the open end 52 into the space 28 and resting the side of the bucket 50 on the bent member 20. The closed end 54 of the bucket 50 can rest against the base member 12 and the support hook arms 44 can support sides of the bucket 50, as shown in FIG. 1.

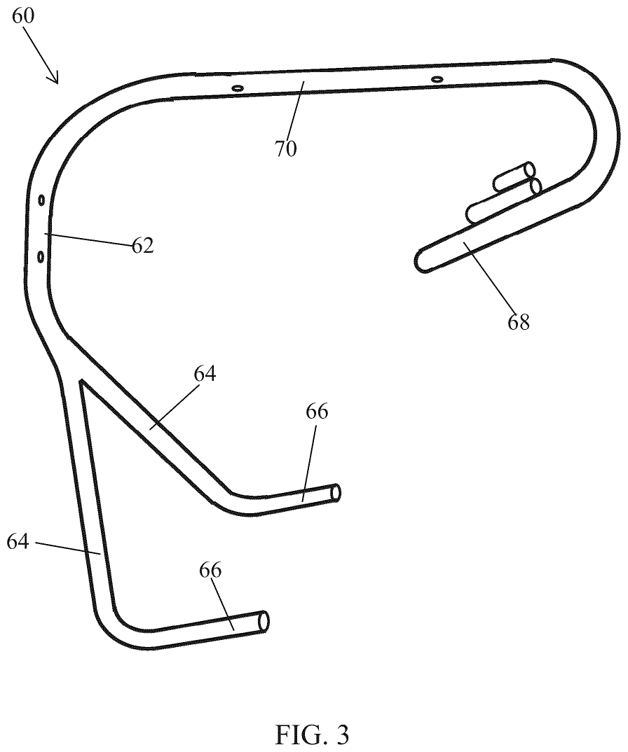

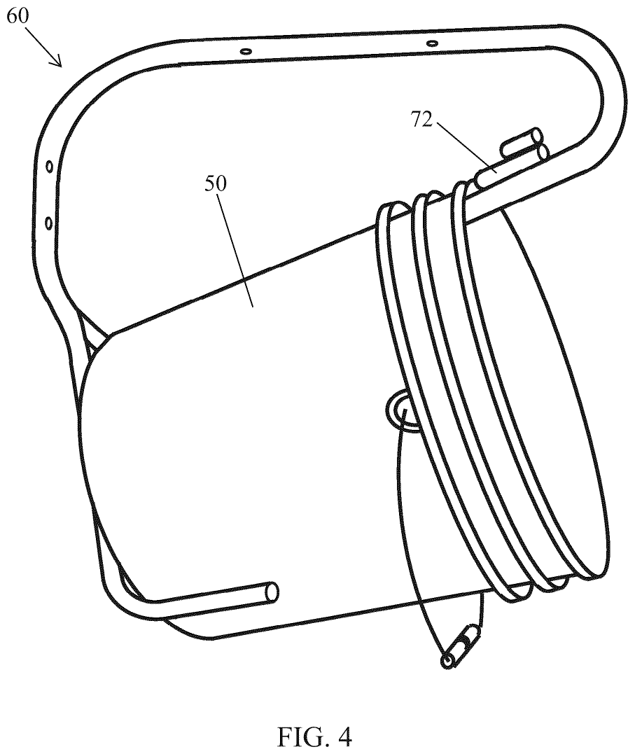

Referring to FIGS. 3 and 4, a shelf bracket and bucket rack 60 can be formed similar to the shelf bracket and bucket rack 10, described above, except that the buck rack 60 may be formed in a tubing style, typically with steel tubing and wire, for example. In the embodiment of FIGS. 3 and 4, there is no diagonal support arm, however, such a support arm may be used in the design. Further, in the embodiment of FIGS. 3 and 4, the base member 62 may split into two legs 64 that then have bucket support arms 66 that extend outward away from the base member 62. The functionality of the shelf bracket and bucket rack 60 may be similar to that of the bucket rack 10 described above, where the hooked end 68 of the upper arm 70 can be inserted into an open end of a bucket and the bucket support arms 66 can retain the bucket on the rack, as shown in FIG. 4. Steps 72 can be provided, similar to that described above, to prevent the bucket from sliding away from the base member 62 as items are removed from the bucket.

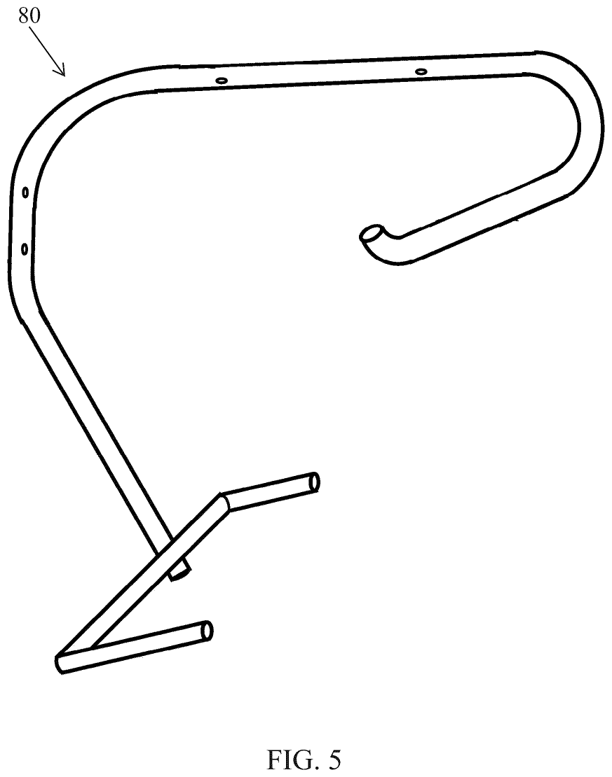

Referring to FIG. 5, another wire-form of the shelf bracket and bucket rack 80 is shown.

The operation of the embodiment of FIG. 5 is similar to that described above.

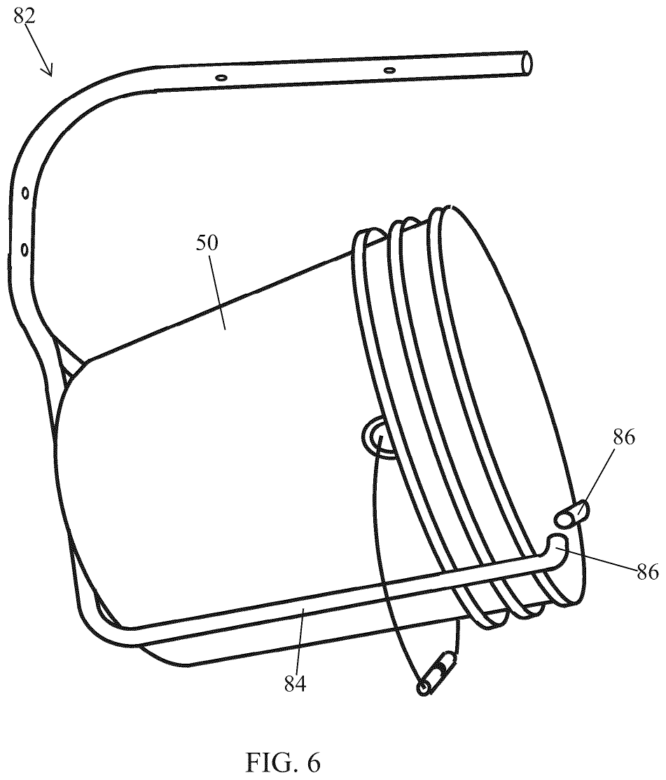

FIG. 6 shows another embodiment of a wire-form shelf bracket and bucket rack 82, where the bucket support arms 84 extend along a length of the bucket 50. The bucket support arms 84 can bend inward with retaining arms 86 that extend over the open end of the bucket 50. The retaining arms 86 can prevent pulling the bucket 50 out of the shelf bracket and bucket rack 82. Such a support arm design may also be used in the shelf bracket 10 described above with respect to FIGS. 1 and 2.

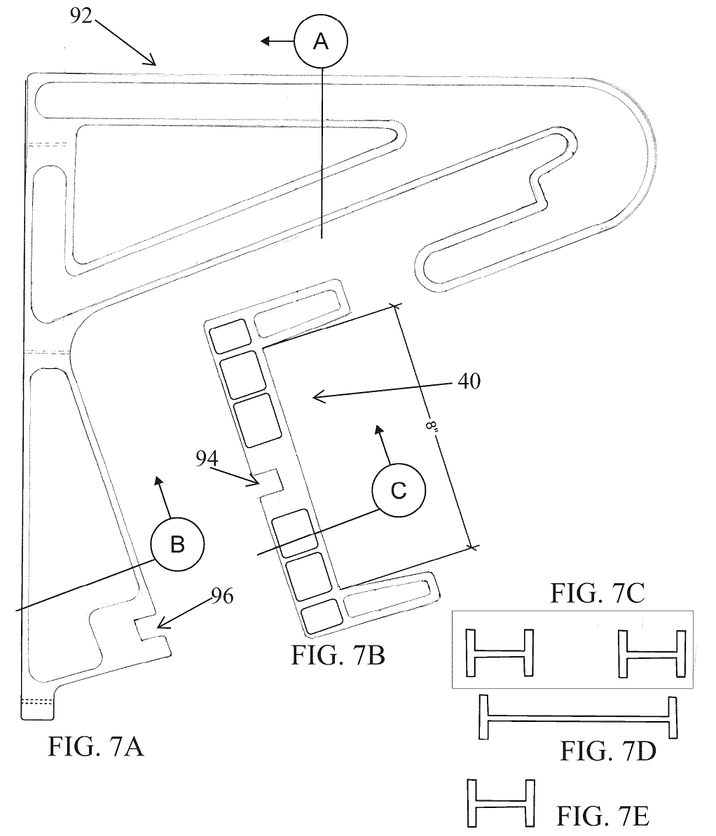

FIGS. 7A through 7E illustrate an embodiment of the shelf bracket and bucket rack formed of two pieces, where the first piece 92 forms the base member, upper arm, diagonal support arm and hooked end as described above with respect to FIGS. 1 and 2. The support hook 40 is shown in FIG. 7B, where the support hook 40 may include a first connector 94 that fits into a second connector 96 formed in the first piece 92. FIGS. 7C through 7E show various cross-sectional views. While FIGS. 7A through 7E show possible design configurations, it should be understood that such may vary depending on the particular application and use specifications.

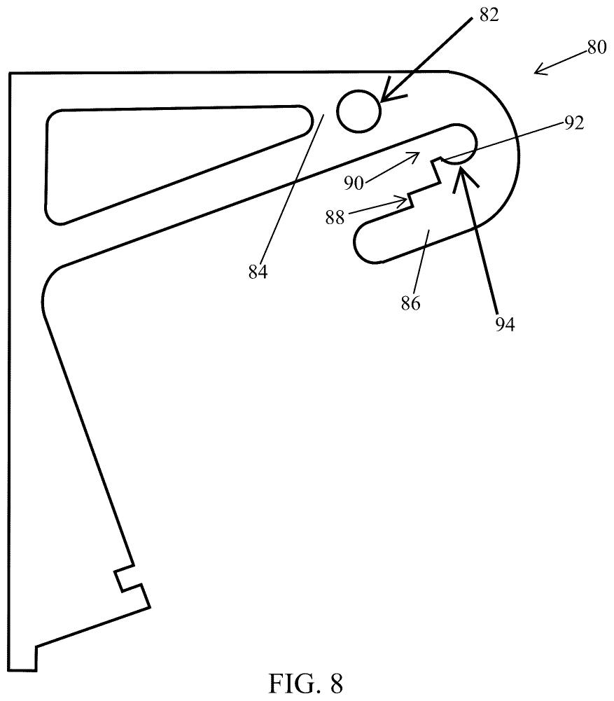

FIG. 8 illustrates an embodiment of a shelf bracket 80 that includes a similar construction to that of FIGS. 7A through 7E, but further includes a closet rod hole 82 formed along an upper arm 84 thereof. A closet rod (not shown) can be supported by the closet rod hole 82, providing a further functionality of the shelf bracket 80.

Further, similar to FIGS. 1 and 2, a bent member 86 can include a plurality of steps 88 on an interior side thereof. A space 90 can be formed between the bent member 86 and the upper arm 84. At an interior corner of the space 90, the bent member 86 can include a hook feature 92, where the inside (upper edge) of the bent member 86 curves upward back toward the upper arm 84, thus providing the feature of a hook, permitting hanging of objects without the objects sliding down the inside edge of the bent member 86.

The bracket, as described above, could be made from any of the following types of materials and methods, including but not limited to, plastic or similar materials through a standard injection molding process or a 3D printer, round, square or rectangular metal tubing that is bent into shape by way of available tubing benders or a mechanical press, sheet metal that is cut & bent with a typical mechanical press, plywood or similar natural materials such as in oriented strand board (OSB), CDX or particle board cut with a computer numerical control (CNC) machine or standard carpentry tools such as saws and drills. These methods reflect the typical and standard processes currently in use but new technology, not yet developed, may also be a viable method of manufacture.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Claim elements and steps herein may have been numbered and/or lettered solely as an aid in readability and understanding. Any such numbering and lettering in itself is not intended to and should not be taken to indicate the ordering of elements and/or steps in the claims.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different ones of the disclosed elements.

The words used in this specification to describe the invention and its various embodiments are to be understood not only in the sense of their commonly defined meanings, but to include by special definition in this specification the generic structure, material or acts of which they represent a single species.

The definitions of the words or elements of the following claims are, therefore, defined in this specification to not only include the combination of elements which are literally set forth. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what incorporates the essential idea of the invention.

What is claimed is:

1. A shelf bracket and bucket rack comprising:
a base member having a back surface operable for attachment to a surface;
an upper arm extending from a top of the back surface, the upper arm extending generally perpendicularly from the base member, the upper arm having an upper surface configured to retain a shelf thereupon;
a bent member formed from a bend at a distal end, relative to the base member, of the upper arm, the bent member extending the upper arm back toward the base member, the bent member having an upper edge facing a lower edge of the upper arm; and
first and second bucket support arms connected to a lower end of the base member, the first and second bucket support arms extending away from the base member, the first and second bucket support arms spaced apart from each other and configured to support a side of a bucket positioned thereupon.

2. The shelf bracket and bucket rack of claim 1, further comprising a closet rod hole formed in the upper arm adjacent the bend.

3. The shelf bracket and bucket rack of claim 1, further comprising a hook formed along an inside surface of the bent member.

4. The shelf bracket and bucket rack of claim 3, wherein the hook is formed from a hooked portion extending upward from an inside edge of the bent member.

5. The shelf bracket and bucket rack of claim 1, further comprising a diagonal support arm extending from the base member, below the upper arm, to a bottom side of the distal end of the upper arm.

6. The shelf bracket and bucket rack of claim 1, further comprising a plurality of steps on an upper portion of the bent member.

7. The shelf bracket and bucket rack of claim 1, wherein the first and second bucket support arms are attached to a support arm base member to form a support bracket having a C-shape, the support arm base member attached to the base member.

8. The shelf bracket and bucket rack of claim 7, wherein the support bracket removably attaches to the base member.

9. The shelf bracket and bucket rack of claim 1, further comprising a bent portion formed on a distal end of the first and second bracket support arms, the bent portion configured to bend around an open end of the bucket when the bucket is placed in the shelf bracket and bucket rack.

10. The shelf bracket and bucket rack of claim 1, wherein the upper arm is formed integrally with the base member and bent member.

11. The shelf bracket and bucket rack of claim 1, wherein the first and second bucket support arms are formed integrally with the base member.

12. A shelf bracket storage apparatus comprising:
a bucket; and
a shelf bracket and bucket rack comprising:
a base member having a back surface operable for attachment to a surface;
an upper arm extending from a top of the back surface, the upper arm extending generally perpendicularly from the base member, the upper arm having an upper surface configured to retain a shelf thereupon;
a bent member formed from a bend at a distal end, relative to the base member, of the upper arm, the bent member extending the upper arm back toward the base member, the bent member having an upper edge facing a lower edge of the upper arm; and
first and second bucket support arms connected to a lower end of the base member, the first and second bucket support arms extending away from the base member, the first and second bucket support arms spaced apart from each other and configured to support a side of the bucket positioned thereupon, wherein
the bucket is removable from the shelf bracket and bucket rack; and
the bucket is configured to rest the bent member inserted into an open end of the bucket, a bottom side of the bucket supported by the first and second bucket support arms, and a closed end of the bucket positioned against the base member.

13. The shelf bracket storage apparatus of claim 12, further comprising a closet rod hole formed in the upper arm adjacent the bend.

14. The shelf bracket storage apparatus of claim 12, further comprising a hook formed along an inside surface of the bent member.

15. The shelf bracket storage apparatus of claim 14, wherein the hook is formed from a hooked portion extending upward from an inside edge of the bent member.

16. The shelf bracket storage apparatus of claim 12, wherein the shelf bracket and bucket rack further comprises a diagonal support arm extending from the base member, below the upper arm, to a bottom side of the distal end of the upper arm.

17. The shelf bracket storage apparatus of claim 12, wherein the shelf bracket and bucket rack further comprises a plurality of steps on an upper portion of the bent member.

18. The shelf bracket storage apparatus of claim 12, wherein the first and second bucket support arms are attached to a support arm base member to form a support bracket having a C-shape, the support arm base member attached to the base member.

19. The shelf bracket storage apparatus of claim 12, wherein the support bracket removably attaches to the base member.

20. The shelf bracket storage apparatus of claim 12, wherein the shelf bracket and bucket rack further comprises a bent portion formed on a distal end of the first and second bracket support arms, the bent portion configured to bend around an open end of the bucket when the bucket is placed in the shelf bracket and bucket rack.
